(19) United States
(12) Patent Application Publication
(10) Pub. No.: US 2007/0180482 A1
(43) Pub. Date: Aug. 2, 2007

(54) Remote imaging system

(75) Inventors: Bentley D. Frink, Wilmington, NC (US); William J. Mason, Wilmington, NC (US)

Correspondence Address: WILLIAM J. MASON;MACCORD MASON PLLC, POST OFFICE BOX 1489, WRIGHTSVILLE BEACH, NC, 28480, US

(73) Assignee: M2M Research, Inc.

(21) Appl. No.: 11/700,675

(22) Filed: Jan. 31, 2007

Related U.S. Application Data
(60) Provisional application No. 60/763,799, filed on Jan. 31, 2006.

(51) Int. Cl. H04N 7/173

(52) U.S. Cl. 725/105

(57) ABSTRACT

A remote imaging system for the unattended acquisition of image data at a first site and wireless transmission of the image data to a remote Internet server via a cellular modem. The system includes at least one analog video camera and a first frame grabber to receive image data in analog format from the video camera and convert the image data to digital format for transmission over the Internet. The invention also includes a method of automatically selecting images for storage. The method includes steps of acquiring a plurality of images of an area, comparing each image against first predetermined criteria, and separating each image that meets said first predetermined criteria from images that do not.

This application claims the benefit of Provisional Application No. 60/763,799, filed Jan. 31, 2006.

### FIELD OF THE INVENTION

The present invention relates generally to a system for collecting and transmitting image data from a remote location for processing on an Internet server and viewing on an Internet website, and more particularly to a system for collecting image information at a remote site, wirelessly transmitting the information to a server via the cellular network, processing the image information on the server, and displaying the resultant image on a website.

### SUMMARY OF THE INVENTION

The present invention is directed to the acquisition of image data at a remote site using an unattended imaging device, and transmission of image data with a cellular modem to an Internet server or peer-to-peer network for processing and display. Generally, the imaging device is comprised of an analog video camera to acquire an image, a frame grabber to capture analog image data relating to a selected image and convert the analog data to digital data, a cellular modem to transmit the image information to the Internet server, a programmable microcontroller to control the timing and functions of the other components, and a power source. The method of the invention includes the steps of acquiring analog image data, converting the analog data to digital image data, wirelessly transmitting the digital data via the Internet to an Internet server, and processing the digital data on the server for display as an image on a website.

The analog video camera may be any NTSC or PAL camera. Generally, analog video cameras mechanically or electronically expose a rectangular array of pixels for a predetermined period of time, with light from the subject being focused onto the pixels by a suitable lens. Each pixel is exposed to light of a given intensity and wavelength. Information regarding the light impinging on each pixel is then transmitted as an analog signal having luminance and chrominance information. An analog voltage level that is proportional to the impinging light's intensity conveys the luminance information. The chrominance information is the difference between a color and a specified reference color having a specified chromaticity and an equal luminance. For example, digital video signals complying with the ITU-R BT 601 4:2:2 format are comprised of three components, luminance Y and chrominance Cr and Cb. In mathematical terms, Cb is the color blue minus luminance (B-Y) and Cr is the color red minus luminance (R-Y).

Other video signals may comprise different chrominance components. However, in order to achieve the ultimate goal of generating a web site viewable image, the luminance and chrominance information must be converted to Red, Green and Blue color space. Fortunately, there are various equations that can be used for this task. See Tables 1 and 2 showing two different sets of equations used for color space conversion.

TABLE 1
Color Space Conversion Equations.

R = 1.164 × (Y − 16) + 1.596 × (Cr − 128)
G = 1.164 × (Y − 16) − 0.392 × (Cb − 128) − 0.813 × (Cr − 128)
B = 1.164 × (Y − 16) + 2.017 × (Cb − 128)

TABLE 2
Color Space Conversion Equations.

R = Y + (Cr − 128) * 1.402
G = Y − (Cb − 128) * 0.34414 − (Cr − 128) * 0.71414
B = Y + (Cb − 128) * 1.772

Tables 1 and 2 represent only two sets of color space conversion equations. Other color space conversion equation sets exist. Usually, one set is chosen over the other as a personal preference or to enhance color performance of a particular camera or monitor.

The camera can be activated to expose the pixel array at predetermined periods by the programmed microcontroller, or can be activated upon sensing of a motion or other variable condition. The camera can be deactivated by the microcontroller program or by the frame grabber upon capture of a selected field or frame from the video stream by the frame grabber.

One image frame of a PAL or NTSC signal is comprised of an odd field and an even field. The odd and even fields of PAL and NTSC signals are interlaced. The frame grabber is synchronized with the camera to capture image data for one image field, i.e., the analog image output from one field of the image array. The analog signal contains both luminance and chrominance information making up one field of the image. The frame grabber converts the field's analog luminance and chrominance information into an array of digital values that can be wirelessly transmitted. If the image is not dynamic the microcontroller program can instruct the frame grabber to digitize the remaining field. However, this is not generally necessary because the missing field can be practically reproduced by interpolating between the scan lines making up the captured field. Moreover, a single field of image data occupies only half the bandwidth of an entire video frame. As a result, the present invention exploits this fact to reduce the cost of transmitting the sampled image in both power budget and carrier fee per image.

The digital data can be transmitted with different transmitters depending on the overall construction and use of the system. In its basic construction, a wireless cellular modem, such as a GPRS, EDGE, RX1TT, CDMA OR WIMAX modem can be hardwired to the microcontroller, which in turn is hardwired to the camera and frame grabber, to transmit collected image data on schedule or demand to an Internet server via the cellular network, e.g., the Cingular network.

Either the modem or the microcontroller includes a TCP/IP stack for packetizing the image data for transmission over a LAN, frame relay or the Internet. The image data can be transmitted by any of the known Internet protocols that include but are not limited to:

AFP, Appletalk Filing Protocol

APPC, Advanced Program-to-Program Communication

BitTorrent

CFDP, Coherent File Distribution Protocol

DHCP, Dynamic Host Configuration Protocol

FTAM, File Transfer Access and Management

FTP, File Transfer Protocol

Gopher, Gopher protocol

HTTP, HyperText Transfer Protocol

IMAP, Internet Message Access Protocol

IRC, Internet Relay Chat

LDAP, Lightweight Directory Access Protocol

Modbus

NNTP, Network News Transfer Protocol

POP3, Post Office Protocol

SIP, Session Initiation Protocol

SMTP, Simple Mail Transfer Protocol

SNMP Simple Network Management Protocol

SSH, Secure Shell

TELNET, TELEphone NETwork

TFTP, Trivial File Transfer Protocol

TSP, Time Stamp Protocol

X.400

X.500

XMPP, Extensible Messaging and Presence Protocol

While the unattended imaging device may be powered by a source of AC power, the device is preferably battery powered so that it can be set up for image gathering at remote locations where no AC power is available. For portability and concealment, if desired, the battery pack used to power the imaging device should be compact, e.g., a pack of 4-6 C or D cell rechargeable batteries. Battery chemistries for the system include but are not limited to lead acid, NiMH, NiCad, Alkaline, Carbon Zinc and Lithium Ion. In some instants such as a temporary remote monitoring application, non-rechargeable batteries are an option. Moreover, other energy options to power the system are available such as energy harvesting and fuel cells. If the device is to be used at a given location for a prolonged period, the power supply can also include a solar panel to recharge the batteries.

When transmitted, the data is stored in a directory on the server for retrieval and processing in order to display the image on a website associated with the server. As used herein, the term “system” is used to refer to the combination of the above imaging device and the server, including the data bases and software on the server.

One of the significant advantages of the present invention is the ability to perform some or all of the processing of the digital data on the server, thereby using the server resources and power for this purpose instead of the needing to provide resources at the remote device or using the limited power budget of the imaging device. As a result, the cost of the remote device and the overall system is reduced, a greater amount of data can be transmitted with the available power budget, and the data is processed at significantly greater speed.

While the camera, frame grabber, microprocessor and modem are physically joined within an enclosure in the basic embodiment, the present invention also contemplates physical separation of one or more of the components from the other components. For example, the modem can also be physically separated from some or all of the other device components, with the image data being wirelessly transmitted to the modem for retransmission to the Internet server.

For instance, the camera, frame grabber and microcontroller can be at a physical location different from the physical location of the modem, with the microcontroller and modem being joined by a wireless connection using a first, relatively short range, wireless transceiver such as a Zigbee, Bluetooth, ultrawideband, a narrow-band radio frequency transmitter, or another type of wireless modem, including laser and infrared emission types. Generally, these wireless transmitters will be capable of transmitting the image information for a few hundred yards.

The modem can be at any location within range of the first transmitter to receive the transmission from the first transmitter and retransmit the data. The data can be immediately retransmitted, or temporarily stored in memory at the modem site. Separate power sources are provided at the camera site and at the modem site, with the power budget needed at the camera site being considerably less due to the demand of the shorter range transmission. Multiple camera modules can be programmed to transmit to a single retransmission modem. In addition, modules designed to collect other types of sensed data can transmit to the modem.

In another alternative, the camera and frame grabber can be combined in a first module at a first physical location while the microcontroller and modem are combined in a second module at a second physical location. The first module includes a short-range transmitter to transmit image data to a receiver in the second module. The second module can include a transmitter to send control data to a receiver in the first module, or the first module can be preprogrammed to collect image data at predetermined times, or triggered by a sensor.

The imaging device can include other components. For example, instead of periodically activating the camera and frame grabber at given times according to a program, the imaging device can include a sensor to detect a changeable condition to activate the camera. For example, the device can be triggered upon sensing of motion within the camera's field of view, or upon the detection of a change in an environmental or atmospheric condition. The device can be programmed to collect information relating to a single image or a plurality of images over a predetermined time range following detection of the variable.

The sensor can be physically attached to the camera or frame grabber, or physically remote from the camera and frame grabber. For example, a sensor module comprised of a sensor and short-range transmitter can be separated from the camera module to detect a triggering variable. Upon detection of the variable, the sensor and a trigger circuit will transmit a triggering signal to the camera module to activate the camera.

As noted, more than one camera module can be used to collect image data for transmission by the modem. For example, one camera can be used to collect color image information during the daytime, while a second camera can be used to collect black and white images during the night. In this case, the device can also include a light source, such as an infrared illuminator, to illuminate the camera's field of view when the camera is activated.

Digital data generated by the frame grabber can be immediately transmitted to the Internet server via the modem. Alternatively, the device can include one or more memory devices, such as flash memory, so that the information can be temporarily stored before transmission.

The present invention includes a daemon that executes an executable file that processes image data transmitted by the remote modem and received by the server. For the purposes of this disclosure a daemon is a computer program that runs continuously in the background of a multitasking operating system. A suitable daemon for initiating scheduling processing of received image data files is the crond daemon, which runs continuously in the server's multitasking environment's background. The crond daemon periodically checks to see if any scheduled jobs need to be executed. If so, it executes them. These jobs are generally referred to as cron jobs and are set using cron tab commands. Preferably, the cron tab is set to execute the image data processing program several times an hour. For example, the cron tab could be set to execute the image data processing program once every ten minutes. Alternately, the daemon could be programmed to constantly check for newly received image data files.

Once a new image file has been located, the image processing program automatically opens the file and its contents are read into the server's memory. The image data processing program can examine the file contents to determine how to process the image data to generate an appropriate image. For example, the image data processing program can read the image data file to determine if the image data contains chrominance data for generating a color image. Moreover, the image data processing program can determine to what extent the image data is compressed. Preferably, the image data will include a file header that gives details about how to process the image data to generate an appropriate image. For example, the file header details could include but are not limited to, the type of image to be generated (e.g., monochrome or color image) as well as the image data compression ratio.

If the image data is determined to be compressed, the image data processing program will automatically decompress the image data. If the image data contains sets of 4:2:2 format cr and cb chrominance values, the missing chrominance values will be created by averaging the adjacent chrominance values within each set. Also, if the luminance data contains only one captured video field, the missing scan lines are created by averaging adjacent scan lines to create the missing scan lines.

Once all the missing data is created, the luminance and chrominance data values are converted into Red, Blue and Green or RGB values so that the generated image can be displayed on a computer. The image data processing program can use either of the sets of equations shown in Tables 1 and 2 above to accomplish this task.

At some point during the processing, the image data processing program adds a bit-mapped or BMP file header to the RGB values. The BMP header includes such information as the image size and resolution. An image file is completely generated once the BMP header is added onto the RGB values or vice versa. The generated image file is then automatically named by the image data processing program, and is automatically written to an image directory on the server for display on a web page or for delivery to a client via an Internet protocol.

Optionally, the image data processing program can further process the generated image. For example, the image data processing program can invoke another program to convert the generated image into another format that can be but is not limited to the image formats such as JPEG, PNG, GIF and PDF. Preferably, a program such as ImageMagick is automatically called using a system command having command line arguments listing the input file name, output file name and file conversion type. Moreover, other software programs can be called to automatically correct substantial barrel distortion caused by wide angle lens.

Preferably, the image data processing program is operated in batch mode when executed by the daemon. In other words, the image data processing program will process all the image data files it locates on the server once it is invoked. Once an image is generated from the image data files, the image data processing program will either hide the parent image data files or delete them so they will not be available for processing the next time the daemon executes the image data processing program. The remaining generated images can be displayed in a web browser using a single script thumbnail gallery with navigation such as the one known as EasyPhpAlbum.

The cameras are preferably interlaced cameras due to cost. That is, the cameras first scan odd lines of the array and then scan even lines of the array to create the video image. The still image captured by the frame grabber is based only on one of the scans, e.g., the scan of the odd lines. The data that would normally be provided by the even line scan is then provided through interpolation by averaging the values of the pixels from the immediately adjacent pixels in the odd lines.

If a higher resolution image is desired with the attendant cost of transmission of twice the data, the invention also contemplates the use of two frame grabbers for each camera, with the first frame grabber capturing image data from the odd line scan and the second frame grabber capturing image data from the immediately following even line scan. The data sets, after conversion to digital data by the frame grabbers are then transmitted to the server, where they are combined into a single image. The invention also contemplates the use of progressive scan cameras, which scan all lines during a single scan. However, the cost in both price of equipment and power budget will render progressive scan cameras prohibitive for most applications.

The present invention also includes a system and method for using an electronic camera and digital processor to detect and acquire images an object moving into or out of an area. For the purposes of this disclosure, a digital processor can be an embedded micro-controller like those found in digital cameras as well as a server computer or a network computer having wide area network (WAN) and local area network (LAN) communication capabilities. The object can be living entities such as humans and animals or nonliving entities such as vehicles like cars, trucks, boats and aircraft.

The method of the present invention automatically acquires and sorts images that capture an object from those that do not by using steps of:
a) acquiring a plurality of images of an area;
b) comparing each image against a first predetermined criteria; and
c) separating each image that meets said first predetermined criteria from images that do not.

In particular, the present method compares each image to the first predetermined criteria before the next image is acquired. The preferred first predetermined criteria is a first image file size threshold. Images having a file size below the threshold will most likely not have captured an object of interest. Therefore, these images will by separated from any images acquired above the threshold and will preferably be discarded. The images having a file size above the threshold will be stored. Moreover, it is preferred that images stored after a first image meeting the first image file size threshold be acquired at a higher image resolution. It is also preferred that images acquired after a first image having a file size that falls below a second predetermined file size threshold be acquired at a lower resolution.

The system is especially useful for nighttime security. For example, a pan, tilt and zoom Internet protocol camera can be mounted to a pole on a construction site. The camera can communicate with a server computer programmed with software to periodically acquire images from the camera and compare the image file size with a predetermined file size threshold. The predetermined threshold can be the file size of an image captured of a dimly lighted area of the construction site. The server software will include algorithms to select and store images that have a file size greater than the file size of an image captured of a dimly lighted area of the construction site.

The preferred system of the present invention also includes at least one motion activated high wattage lamp for illuminating an area under surveillance one or more objects move within the area. Normally, the lamp will be off and the server will acquire images that have file sizes that are below the predetermined file size threshold. These acquired images will be discarded. However, when an object moves within the area under surveillance a motion sensor in communication with the lamp will signal for it to turn on. The area will then be illuminated and the server will acquire images from the camera that will have file sizes that exceed the predetermined file size threshold. These images of the illuminated scene will be stored on the server for concurrent or later dissemination to client computers. Further still, the server software preferably will acquire higher resolution images from the camera once the software determines the area is illuminated. Moreover, the server preferably acquires lower resolution images once the lamp turns off after a predetermined time delay. Image resolutions can be any resolution that the camera is capable of capturing.

Image acquisition and comparisons of the images against the predetermined file size threshold can occur at video frame rates. Therefore, video of the scene can be stored if desired. Otherwise, image acquisition and sampling against the file size criteria can range from once a second to once a minute. Slower image acquisition is possible with the present system, but is not recommended for security purposes. Time-lapse photography is one mode of operation where slow acquisition rates may make sense.

### BRIEF DESCRIPTION OF THE DRAWINGS

FIG. 1 is a schematic illustration of one embodiment of the system.

FIG. 2 is a schematic illustration of a second embodiment of the system.

FIG. 3 is a schematic illustration of a third embodiment of the system.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

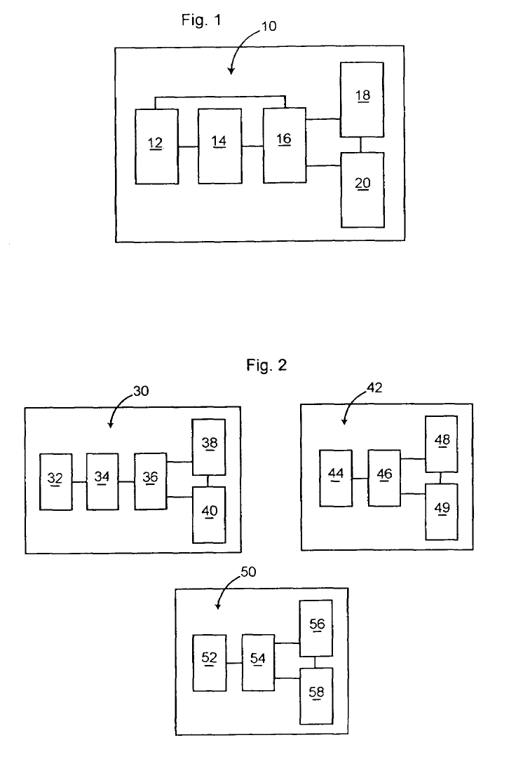

As best illustrated in FIG. 1, the basic system of the invention is comprised of an imaging device, generally 10, to transmit image data to a web server via the cellular network and the Internet. Device 10 is comprised of a camera 12, a frame grabber 14, a programmable microprocessor 16, a modem 18 and a power supply 20.

While the components of device 10 are shown arranged in a particular communication relationship, it will be appreciated by one skilled in the art that other communication relationships are possible. For example, instead of camera 12 being controlled by microprocessor 16, control can be via frame grabber 14. Also, data can be transmitted to modem 18 from frame grabber 14 instead of via microprocessor 16.

FIG. 2 illustrates an example of a modular system comprised of a camera module, generally 30, that includes camera 32, frame grabber 34, microprocessor 36, short-range transceiver 38, and power supply 40. Modem module, generally 42, is comprised of modem 44, microprocessor 46, and power supply 48 and transceiver 49. Multiple camera modules may communicate with the modem module. The modular system may optionally contain other modules, such as sensor module, generally 50, that includes sensor 52, microprocessor 54, short-range transmitter 56 and power supply 58.

Sensor 52 may be one of several commercially available sensors used to detect a change in a sensed condition and output an electronic value indicative of the state of the sensed variable. The sensed condition may be, for example, an environmental condition, such as temperature, visibility, water level, barometric pressure, etc. Sensed data may be used to trigger one or more camera modules, or collected and transmitted to the web server for other reasons. The sensed data may be temporarily stored prior to transmission.

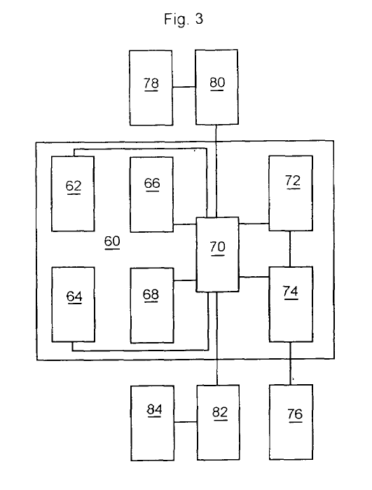

FIG. 3 illustrates another imaging device, generally 60, comprised of color camera 62, black and white camera 64, first frame grabber 66, second frame grabber 68, microprocessor 70, modem 72, battery pack 74, and solar panel 76. Device 60 also includes motion sensor 78 with a trigger circuit 80, light sensor 82, and an infrared illuminator 84.

In the operation of the system of FIG. 1, camera 12 acquires one or more images and transmits image data in analog format to frame grabber 14. Frame grabber 14 captures data relating to one of the images transmitted and converts the image data to digital format. Upon capture of the data, camera 12 is deactivated by microcontroller 16, or by frame grabber 14. Digital image data is then sent via modem 18 via the cellular network and the Internet to a web server.

A computer program product comprising a computer readable program embodied therein installed in the server memory and readable by the processor processes received and stored image data to generate a processed image. As used herein, the term “computer program product” is used to generally refer to removable storage unit, a hard disk installed in hard disk drive, or a carrier wave or other signal carrying software over a communication path (wireless link or cable) to a communication interface. A computer useable medium can include magnetic media, optical media, or other recordable media, or media that transmits a carrier wave. These computer program products are means for providing software to the computer system.

Computer programs are stored in memory and, when executed, enable the computer system to perform the features of the present invention. In particular, the computer programs, when executed, enable the processor to perform the features of the present invention. Computer programs such as that described herein are typically distributed as part of a computer program product that has a computer useable media or medium containing the program code. Therefore, “media”, “medium”, “computer useable medium”, or “computer useable media”, as used herein, may include a diskette, a tape, a compact disc, an integrated circuit, a programmable logic array (PLA), a remote transmission over a communications circuit, a remote transmission over a wireless network such as a cellular network, or any other medium useable by computers with or without proper adapter interfaces. Note that examples of a computer useable medium include but are not limited to palpable physical media, such as a CD Rom, diskette, hard drive and the like, as well as other non-palpable physical media, such as a carrier signal, whether over wires or wireless, when the program is distributed electronically.

Although the enabling instructions might be “written on” a diskette or tape, “stored in” an integrated circuit or PLA, “carried over” a communications circuit or wireless network, it will be appreciated, that for purposes of the present invention described herein, the computer useable medium will be referred to as “bearing” the instructions, or the instructions (or software) will be referred to as being “on” the medium. Thus, software or instructions “on” a medium is intended to encompass the above and all equivalent ways in which the instructions or software is associated with a computer useable medium.

The computer program may perform several steps, not necessarily in the order described below, in generating this representation. First, the program performs the step of identifying the artwork and framing components from their placement on the template or from other features. The dimensions of the artwork and components are determined by comparing the dimensions of the calibration mark with the relative dimensions of the artwork and components.

The software program can initially determine if the image data contains chrominance data and the extent to which the image data may have been compressed. This information may be included in a header file accompanying the image data. The program can then decompress the image data, if appropriate. Missing chrominance values can be created by averaging adjacent chrominance values. Missing scan lines can be created by averaging adjacent scan lines. Luminance and chrominance values can be converted into RGB values.

The program can also perform the steps of adding a BMP header file to the RGB values to generate the image file and store the image file in an image directory for access by an image gallery program. The image file can also be converted to JPEG or another format for display. The software program can also correct barrel and other types of image distortion.

The method of the invention is performed in a similar manner with the modular system illustrated in FIG. 2. Specifically, an image is acquired by camera 32, converted to digital data by frame grabber 34, and then transmitted to modem module 42 by transmitter 38. The data is then retransmitted to the server by modem 44 for processing and display.

In operation of the imaging device illustrated in FIG. 3, motion detected by sensor 78 initiates a trigger signal from circuit 80 to microprocessor 70. Microprocessor 70 determines light level from information provided by sensor 82. If sufficient ambient light is available, microprocessor 70 causes activation of camera 62. If sufficient ambient light is not available, microprocessor 70 causes activation of camera 64 and infrared illuminator 84. Frame grabber 66 captures the image data from an odd scan by the activated camera and frame grabber 68 captures the image data from the immediately following even scan. The activated camera is then deactivated upon capture of data by both frame grabbers. Captured data is converted by both frame grabbers to digital data and transmitted via modem 72 to a web server.

Certain modifications and improvements will occur to those skilled in the art upon a reading of the foregoing description. It should be understood that all such modifications and improvements are properly within the scope of the invention.

What is claimed is:

1. An apparatus for the unattended acquisition of image data at a first site and wireless transmission of the image data to a remote Internet server via a cellular modem comprising:
a) at least one analog video camera;
b) a first frame grabber to receive image data in analog format from the video camera and convert the image data to digital format; and
c) a cellular modem to transmit the image data from the frame grabber to an Internet server.

2. The apparatus of claim 1, wherein said apparatus include a programmable microcontroller to control said modem.

3. The apparatus of claim 1, further including memory for storing said image data prior to transmission of said data.

4. The apparatus of claim 1, wherein said apparatus is battery powered.

5. The apparatus of claim 1, including a first analog camera for color image acquisition and a second analog camera for black and white image acquisition.

5. The apparatus of claim 1, wherein said analog camera is an interlaced camera that conducts an odd line scan and an even line scan for each image, and said first frame grabber captures the image data from only one of said scans.

6. The apparatus of claim 1, further including a second frame grabber, wherein said analog camera is an interlaced camera that conducts an odd line scan and an even line scan for each image, said first frame grabber capturing the image data from the odd line scan and said second frame grabber capturing the image data from the even line scan.

7. The apparatus of claim 1, further including a motion sensor and trigger circuit, said camera being activated responsive to said trigger circuit.

8. A method of automatically selecting images for storage, comprising steps of:
a) acquiring a plurality of images of an area;
b) comparing each image against a first predetermined criteria; and
c) separating each image that meets said first predetermined criteria from images that do not.

9. The method of claim 8, wherein each image is compared to said first predetermined criteria before the next image is acquired.

10. The method of claim 8, wherein said first predetermined criteria is a first predetermined image file size threshold.

11. The method of claim 8, wherein said separated images meeting said first predetermined image file size threshold are stored.

12. The method of claim 8, wherein said images are acquired at a higher resolution after a first image meeting said first predetermined criteria is acquired.

13. The method of claim 8, wherein said images are acquired at a lower resolution after a first image meeting a second predetermined criteria is acquired.

14. The method of claim 13, wherein said second predetermined criteria is a second predetermined image file size threshold.

15. The method of claim 8, wherein said plurality of images comprises images of a substantially dark scene and a substantially illuminated scene.

16. A method for the unattended acquisition of image data at a remote site and display of an image based on said data over the Internet comprising:
a) acquiring image data in analog format at the remote site;
b) converting the image data into digital format at the remote site;
c) transmitting the image data from the remote site to a server via the cellular network and the Internet;
d) processing the image data on the server into an image suitable for display; and
e) displaying the image on a website in response to a viewer request.

17. The method of claim 16, wherein said image data is stored prior to being transmitted.

18. The method of claim 16, including providing a first analog camera for color image data acquisition and a second analog camera for black and white image data acquisition, and selectively acquiring image data with one of said cameras.

19. The method of claim 16, wherein said image data is converted to digital data with a frame grabber.

20. The method of claim 16, wherein said data is acquired with an interlaced camera that conducts an odd line scan and an even line scan for each image, and only one of said scans is converted into digital format.
